(19) United States
(12) Patent Application Publication
(10) Pub. No.: US 2026/0306216 A1
(43) Pub. Date: Oct. 8, 2026

(54) WEDGELESS SECTIONAL MATRIX SYSTEM FOR DENTAL RESTORATIONS

(71) Applicant: Jaemin Lee, Innisfil Beach (CA)

(72) Inventor: Jaemin Lee, Innisfil Beach (CA)

(21) Appl. No.: 19/367,174

(22) Filed: Oct. 23, 2025

Related U.S. Application Data
(60) Provisional application No. 63/782,726, filed on Apr. 3, 2025.

(51) Int. Cl. A61C 5/85

(52) U.S. Cl. CPC A61C 5/85

(57) ABSTRACT

A dental implement for inserting a matrix band. The implement includes an open ring with flexible legs that define a gap therebetween and a body positioned on at least one of the legs that is configured to engage one of the flexible legs. The implement includes a flexible blade configured to releasably connect to the body and to retain a matrix band. When the implement is inserted in a patient's mouth to position the matrix band along a first tooth, the blade is configured to extend between the first tooth and a second tooth adjacent the first tooth, and when the leg is disengaged from the body, the blade moves to press a portion of the matrix band against a portion of the first tooth.

### PRIORITY CLAIM/INCORPORATION BY REFERENCE

This application is a Non-Provisional Patent Application of U.S. Provisional Patent Application No. 63/782,726, titled “Wedge-less Sectional Matrix System” and filed Apr. 3, 2025, which is herein incorporated by reference in its entirety.

### FIELD OF THE TECHNOLOGY

Certain embodiments of the disclosure relate to a wedge-less sectional matrix system for use in dental restorations. More specifically, the system is a reusable dental separator that creates spaces between adjacent dentition and helps contour restorative material around the contact area of a tooth by causing a matrix band to follow the emergence profile of the tooth surface after placement of the separator.

### BACKGROUND

A dental separator and sectional matrix are used in dentistry to restore posterior proximal surface caries of a tooth. After the decayed area of the tooth has been removed, a restorative material is used to fill the gap in, and restore, the tooth. Resin composite is often used as a restorative filling material. Resin composite also goes through polymerization shrinkage after undergoing a curing process with a light, making it difficult to create proper contact surfaces for the treated tooth. Creating a tight contact area is important in order to prevent food impaction between the restored tooth surface and an adjacent tooth. A sectional matrix band with various sized wedges may be used to shape and contour the filling material against the natural tooth surface and hold the restorative material in place until it sets, creating a stable, smooth surface convexity around the contact area and anatomical cervical emergence without an overhang near the cervical margin of the restoration. A sectional matrix band is inserted between teeth by a dental separator.

Wedges are commonly used to stabilize the matrix band after it has been inserted. Wedges are placed either buccally and/or lingually against the matrix band and between the tooth to be treated (or prepped tooth) and an adjacent tooth. Sometimes multiple wedges are utilized at once in the same proximal space. Wedges help stabilize the matrix band so it forms a cervical seal gingival to the prepped margin. A wedge is also used to prevent an overhang. Ill-fitting wedges or inadequately placed ones can impinge on the matrix, resulting in distortion and creating a suboptimal emergence profile on restoration. Further, unlike circumferential matrices, sectional matrices are passively positioned and tend to move until the wedge(s) is/are securely positioned into place. Even then, subsequently applying forces from the dental separator buccolingually or the movement of patient's soft tissue can shift the matrix and open up gaps between the matrix and the prepped tooth. Also, multiple wedges (which are often made of plastic or wood) are often wasted in the course of trying to find the correct fit for the wedge in the space between teeth.

### SUMMARY

Certain aspects of the present technology provide a dental implement for inserting a matrix band. The implement includes an open ring with flexible legs and a body positioned on at least one of the legs and that is configured to releasably engage the matrix band. The implement includes a shaft that can move axially within the body. When the implement is inserted in a patient's mouth to position the matrix band along a first tooth, the shaft is configured to extend out of the body and between the first tooth and a second tooth adjacent the first tooth and move to apply pressure on the matrix band to press the matrix band against a portion of the first tooth.

In some embodiments, the implement may include a flexible blade that is configured to receive the shaft and extend between the first tooth and second tooth with the shaft. The shaft may be a hex key, and the hex key is received in a cylinder in the body, and the cylinder is shaped to correspond to the shape of the hex key such that rotation of the cylinder causes rotation of the hex key. The body may include a gear system that includes (i) a gear knob external of the body and that is connected to a first gear in the body and (ii) a second gear connected to the cylinder and that engages the first gear, wherein rotation of the gear knob causes the cylinder and the hex key to rotate. The gear system may include a ratchet wheel connected to an end of the leg and a gear connected to the cylinder that engages the ratchet wheel, wherein rotation of the ring causes the ratchet wheel to rotate in a first direction, which causes the gear and cylinder to rotate in a second direction. The gear system may further include a pawl that is configured to engage the ratchet wheel and a control lever, wherein the control lever can be moved to cause the pawl to engage and disengage the ratchet wheel. The blade may include an extension that is configured to be positioned in a pathway in the body and extend from an exit in the body and releasably engage the matrix band. The blade may include first and second blade portions connected by a flexible arch and a body is positioned on both legs and wherein the shaft of one of the bodies is connected to the first blade portion and the shaft of the other body is connected to the second blade portion. The blade may include first and second blade portions connected by a flexible arch, wherein the body is configured to receive first and second shafts, the first shaft being connected to the first blade portion and the second shaft being connected to the second blade portion. The body may include a gear system that is configured to rotate the first shaft a first direction and rotate the second shaft a second direction opposite the first direction.

Certain aspects of the present technology provide a dental implement for inserting a matrix band. The implement includes an open ring body with flexible legs that define a gap therebetween and a body positioned on at least one of the legs and that is configured to engage one of the flexible legs. The implement includes a flexible blade configured to releasably connect to the body and to retain a matrix band. When the implement is inserted in a patient's mouth to position the matrix band along a first tooth, the blade is configured to extend between the first tooth and a second tooth adjacent the first tooth and move to press a portion of the matrix band against a portion of the first tooth.

In some embodiments the implement may further include a hex key that is received in a cylinder in the body and the cylinder is shaped to correspond to the shape of the hex key such that rotation of the cylinder causes rotation of the hex key. The implement may include a gear system including (i) a gear knob external of the body and that is connected to a first gear in the body and (ii) a second gear connected to the cylinder and that engages the first gear, wherein rotation of the gear knob causes the cylinder and the hex key to rotate (duplicate statement). The blade may include an extension that is configured to be positioned in a pathway in the body and extend from an exit in the body and releasably engage the matrix band. The gear system may include a ratchet wheel connected to an end of the leg and a gear connected to the cylinder that engages the ratchet wheel, wherein rotation of the ring causes the ratchet wheel to rotate in a first direction, which causes the gear and cylinder to rotate in a second direction (duplicate statement). The blade may include first and second blade portions connected by a flexible arch and the two blade portions and a body is positioned on both legs and wherein the shaft of one of the bodies is connected to the first blade portion and the shaft of the other body is connected to the second blade portion. The blade may include a head configured to releasably engage a notch of the body, wherein when the body is released from the open ring body, the head disengages from the notch.

Certain aspects of the present technology provide a dental implement including an open ring with flexible legs that define a gap there between, a body positioned on an end of each leg, wherein each body includes a gear system and a hex key that can move within the body, and a flexible blade mounted to each hex key that is configured to retain the matrix band. The legs are configured (i) to move away from each other in order to position the matrix band on a first tooth and (ii) to move toward each other such that each body engages the first tooth and a second tooth adjacent the first tooth and the blades disengage from the matrix band. The shafts are configured to (i) be moved axially toward each other between the first tooth and the second tooth such that the blades press against the matrix band, and (ii) be rotated via the gear system such that the blades rotate and press against the matrix band proximate the gingival margin.

In some embodiments, the hex key is received in a cylinder in the body and the cylinder is shaped to correspond to the shape of the hex key such that rotation of the cylinder by the gear system causes rotation of the hex key.

Certain aspects of the present technology provide a method for securing a matrix band to a tooth including the steps of providing an open ring with flexible legs and a body positioned on at least one leg, connecting a flexible blade to the body, releasably connecting a matrix band to the flexible blade, positioning the matrix band along a first tooth, and flexing the legs to release the matrix band and cause the blade to secure the matrix in place against a prepared surface of the tooth. In some embodiments, the body may include a gear or lever that operates to cause the blade to push against the matrix and in a further embodiment the body may include a shaft that operates to engage the blade to move it against the matrix.

### BRIEF DESCRIPTION OF THE DRAWINGS

FIG. 1 illustrates a top isometric view of a ring separator device according to an embodiment of the present technology.

FIG. 2 illustrates a top isometric view of the ring separator device of FIG. 1 with a tine body removed.

FIG. 3 illustrates a top isometric view of the ring separator device of FIG. 1 in an expanded position.

FIG. 4 illustrates a top isometric view of the ring separator device of FIG. 1 with a matrix band mounted thereto.

FIG. 5 illustrates a top isometric view of the ring separator device of FIG. 1 positioned with the matrix band inserted along a tooth needing restoration.

FIG. 6a illustrates an isometric view of a matrix band according to an embodiment of the present technology.

FIG. 6b illustrates an isometric view of a doubled sided matrix band according to an embodiment of the present technology.

FIG. 7 illustrates a side view of the ring separator device of FIG. 5.

FIG. 8 illustrates a front isometric view of a tine body pad according to an embodiment of the present technology.

FIG. 9 illustrates a front isometric exploded view of a portion of a tine body and a pad according to an embodiment of the present technology.

FIG. 10a illustrates a cutaway side view of a tine body according to an embodiment of the present technology.

FIG. 10b illustrates a second cutaway side view of the tine body of FIG. 10a.

FIG. 10c illustrates a third cutaway side view of the tine body of FIG. 10a.

FIG. 10d illustrates a cutaway front view of a tine body of FIG. 10a.

FIG. 10e illustrates a second cutaway front view of the tine body of FIG. 10a.

FIG. 10f illustrates a third cutaway front view of the tine body of FIG. 10a.

FIG. 10g illustrates a fourth cutaway front view of the tine body of FIG. 10a.

FIG. 10h illustrates a cutaway top view of a tine body of FIG. 10a.

FIG. 10i illustrates a second cutaway top view of the tine body of FIG. 10a.

FIG. 10j illustrates a third cutaway top view of the tine body of FIG. 10a.

FIG. 10k illustrates a cutaway side view of a tine body according to another embodiment of the present technology.

FIG. 11a illustrates a top isometric view of a blade and hex key according to an embodiment of the present technology.

FIG. 11b illustrates a top isometric view of the blade and hex key of FIG. 11a separated.

FIG. 11c illustrates a top isometric view of a double blade according to an embodiment of the present technology.

FIG. 11d a top isometric view of the double blade of FIG. 11c being compressed.

FIG. 11e illustrates a top isometric view of a double blade according to an embodiment of the present technology.

FIG. 11f illustrates another top isometric view of the double blade of FIG. 11e.

FIG. 11g a top isometric view of the double blade of FIG. 11e being compressed.

FIG. 11h is a side view of the blade of FIG. 11a.

FIG. 12a illustrates a cross-sectional side view of a hex key and a blade positioned between two teeth according to an embodiment of the present technology.

FIG. 12b illustrates a cross-sectional side view of the hex key and a blade of FIG. 12a rotated to a different position.

FIG. 13a illustrates a top view of two hex keys and blades inserted between adjacent teeth according to an embodiment of the present technology.

FIG. 13b illustrates a top view of the hex keys and blades of FIG. 13a wherein the blades have been compressed to fill gaps between the teeth.

FIG. 14a illustrates a side isometric view of a ring separator device positioned with the matrix band inserted along a tooth needing restoration according to an embodiment of the present technology.

FIG. 14b illustrates a top view of the device of FIG. 14a.

FIG. 14c illustrates a top isometric exploded view of a ring separator device according to an embodiment of the present technology.

FIG. 15a illustrates a side isometric view of the device of FIG. 14a in operation.

FIG. 15b illustrates a side isometric view of the device of FIG. 14a in operation.

FIG. 16 illustrates a top view of a tine body of the embodiment shown in FIGS. 14a-14c.

FIG. 17 illustrates a side cutaway view of a tine body of the embodiment shown in FIGS. 14a-14c.

FIG. 18 illustrates a side cutaway view of a tine body according to an embodiment of the present technology.

FIG. 19a illustrates a side cutaway view of a tine body according to an embodiment of the present technology.

FIG. 19b illustrates a second cutaway side view of the tine body of FIG. 19a.

FIG. 19c illustrates a third cutaway side view of the tine body of FIG. 19a.

FIG. 19d illustrates a top cutaway view of the tine body of FIG. 19a.

FIG. 19e illustrates a second top cutaway view of the tine body of FIG. 19a.

FIG. 19f illustrates a third top cutaway view of the tine body of FIG. 19a.

FIG. 20a illustrates a top isometric view of the two hex keys and a double blade according to an embodiment of the present technology.

FIG. 20b illustrates a top isometric view of the hex keys inserted in the double blade of FIG. 20a.

FIG. 20c illustrates a top isometric view of the hex keys inserted in the double blade in an expanded position of FIG. 20a.

FIG. 20d illustrates a cross-sectional view of the double blade of FIG. 20a.

FIG. 20e illustrates a cross-sectional view of the expanded double blade of FIG. 20a.

FIG. 20f illustrates a cross-sectional side view of the hex keys and double blade of FIG. 20a inserted between adjacent teeth.

FIG. 20g illustrates a cross-sectional side view of the hex keys and double blade of FIG. 20a inserted between adjacent teeth with the blades pressing against matrix bands.

FIG. 21a illustrates a top isometric view of a hex blade holder according to an embodiment of the present technology.

FIG. 21b illustrates a close-up view of a portion of the holder of FIG. 21a.

FIG. 22a illustrates a top isometric view of pliers according to an embodiment of the present technology.

FIG. 22b illustrates a close-up view of a portion of the holder of FIG. 22a.

FIG. 23 illustrates a cutaway front view of a tine body and a flexible blade according to an embodiment of the present technology.

FIG. 24 illustrates an isometric view of the blade of FIG. 23.

FIG. 25 illustrates an isometric view of a head of the blade of FIG. 23 and a notch of the body of FIG. 23.

FIG. 26a illustrates a front view of the blade 300 of FIG. 23 being positioned between teeth above the gum line by the tine bodies of FIG. 23.

FIG. 26b illustrates a front view of the blade 300 of FIG. 23 being further positioned between teeth above the gum line by the tine bodies of FIG. 23.

FIG. 26c illustrates a front view of the blade 300 of FIG. 23 being released by the tine bodies of FIG. 23.

The foregoing summary, as well as the following detailed description of certain embodiments of the present technology, will be better understood when read in conjunction with the appended drawings. For the purpose of illustrating the technology, there is shown in the drawings, certain embodiments. It should be understood, however, that the present technology is not limited to the arrangements and instrumentality shown in the attached drawings.

### DETAILED DESCRIPTION

Embodiments of the present technology include a dental implement in the form of a ring separator device with a pair of depending and converging tines that apply pressure buccolingually on an interproximal area between teeth to increase space between two adjacent teeth and to secure a matrix band to at least one of the teeth such that the tooth can be restored.

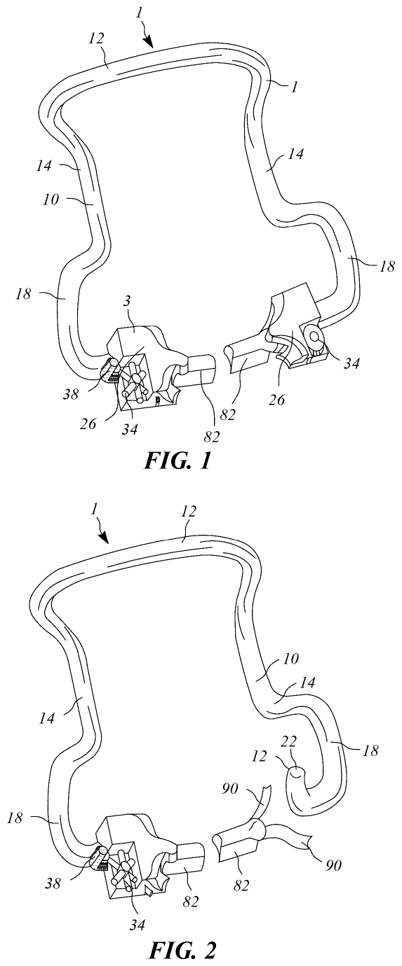

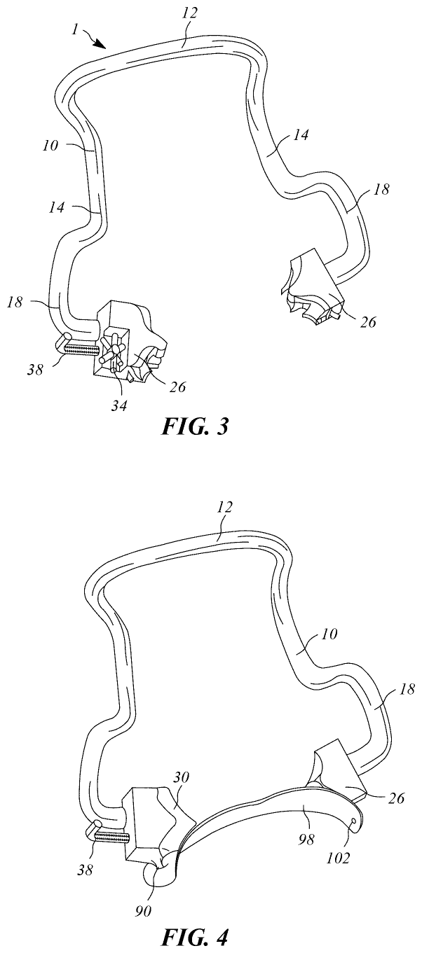

With respect to FIGS. 1-5 and 7, a ring separator device 1 includes a body 10 having an open ring shape. The body 10 includes a pair of legs 14 that extend downward and then forward from a central portion or handle 12 and define C-shaped notches 18 that end with tines 22 at distal ends of the legs 14 that extend generally upward. With reference to FIG. 3, the legs 14 have a spring tension and can be pulled apart from each other and pushed toward each other. By way of example only, the body 10 may be made of a metal or an alloy or other material that provides it with spring characteristics.

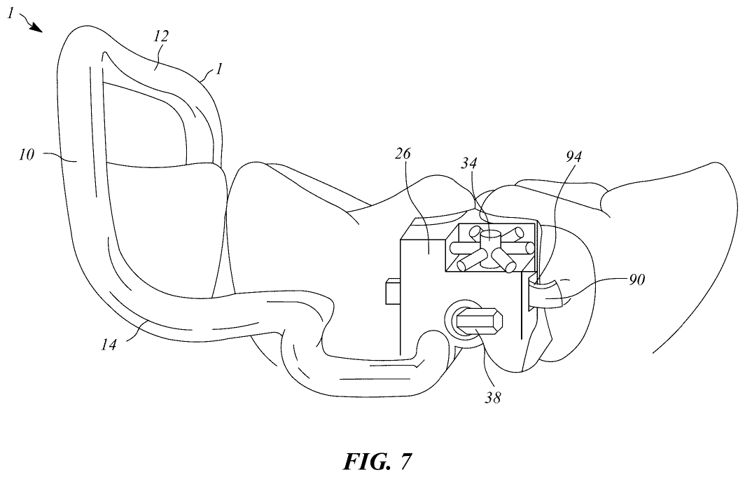

A secondary tine body 26 is formed over each underlying tine 22. Inside each tine body 26, the tine 22 extends in a generally upward direction from an end of the C-shaped notch 18, and the distal ends of the tines 22 are tilted slightly toward each other, which allows for the creation of inward and downward forces by the tine bodies 26 against dentition buccolingually. As shown in FIG. 5, the tine bodies 26 are configured to engage two adjacent teeth, and, with reference to FIGS. 5 and 7, each tine body 26 includes a pad 30 that follows the contour of the teeth for better adaptation. The pad 30 surface may be made of a medical grade silicone, rubber, or other elastomeric material to provide a non-slip surface for better adaptation to the teeth surfaces and to prevent slippage of the ring device 1 from the teeth surfaces. The rest of the tine body 26 may be made of a heat-resistant polymer or stainless steel, or similar metal alloy to provide a compartment in the tine body 26 for a gear system.

Each tine body 26 can include a gear system, although in some embodiments only one tine body 26 may include a gear system (or no gear at all). With respect to FIGS. 1-5 and 7, the gear systems include an external gear knob 34 and a shaft or rod 38. By way of example only, the shaft or rod 38 is an L-shaped hex key. Alternatively, the shaft or rod 38 can have different shapes. For example, it may have something besides six sides and/or can have different shapes than an L-shape.

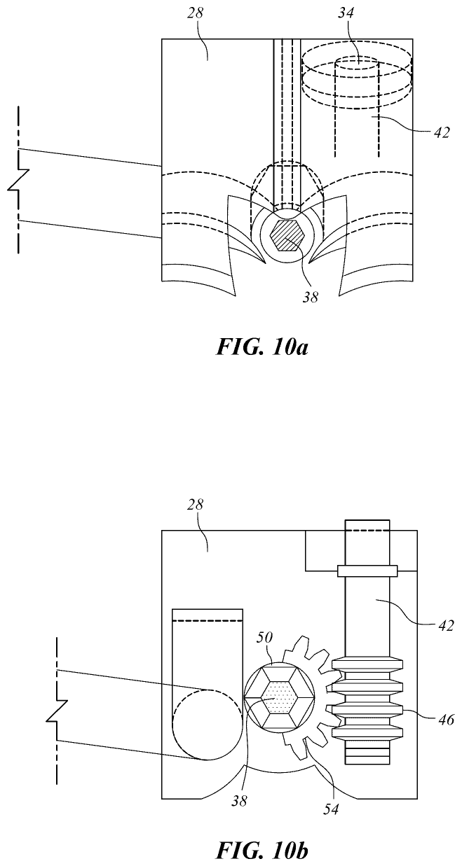

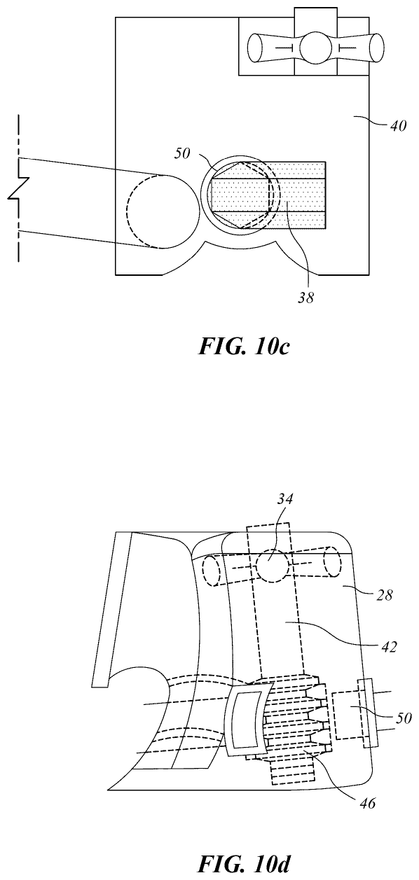

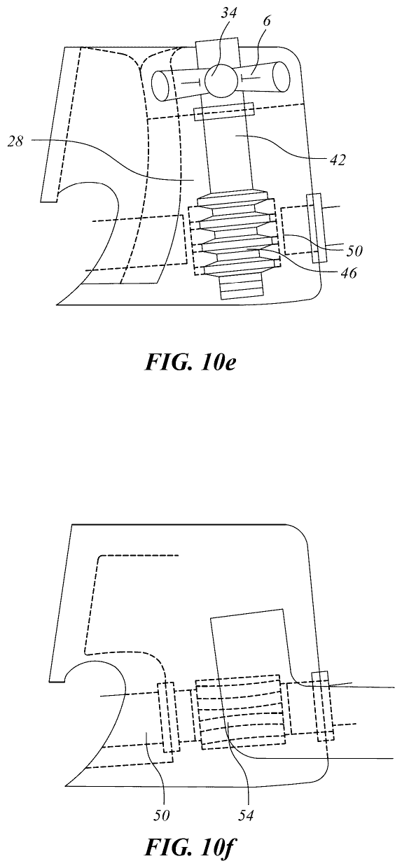

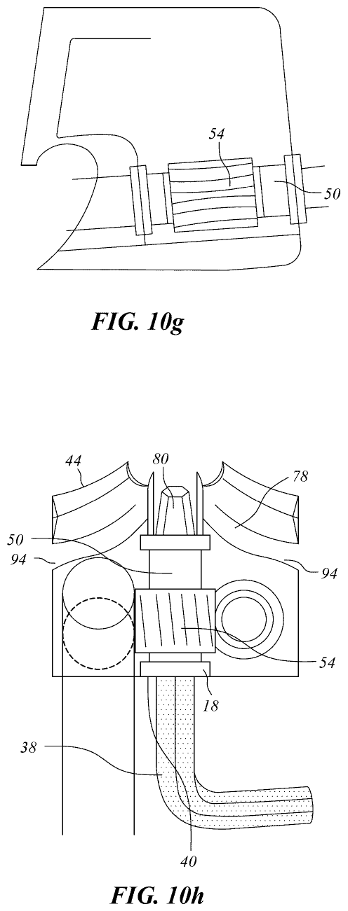

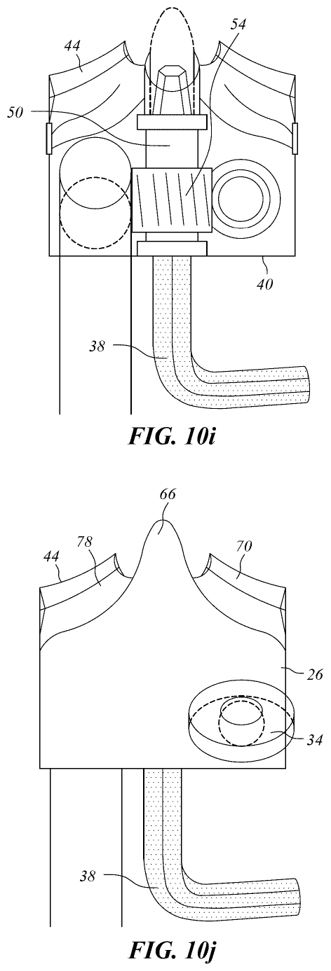

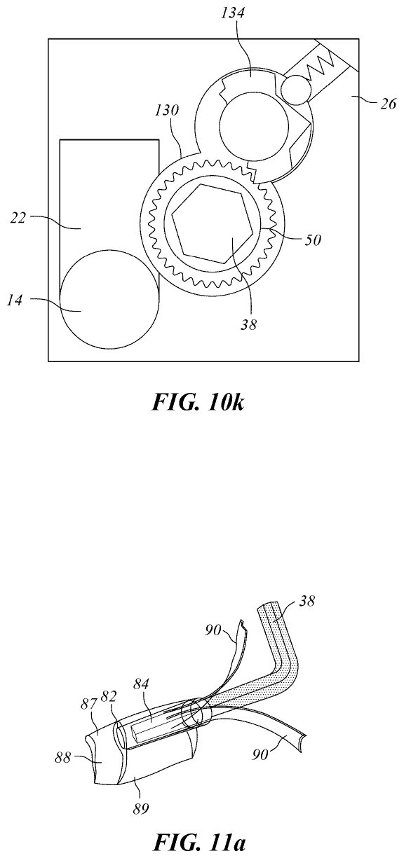

With respect to FIGS. 10a-10j, the external gear knob 34 is connected to a generally vertical shaft 42 inside a compartment 28 in the tine body 26, and the vertical shaft 42 includes a worm 46. The hex key 38 is received inside a generally horizontal cylinder 50 passing through the tine body compartment 28, either in a linguo-buccal direction or a bucco-lingual direction, and the horizontal cylinder 50 includes a worm wheel 54 that is configured to engage the worm 46. The hex key 38 is inserted into the cylinder 50 from a proximal side 40 of the tine body to a distal side 44 of the tine body 26. The inner surface of the horizontal cylinder 50 has a hexagonal cross-section, which corresponds to and accommodates the L-shaped hex key 38 such that the hex key 38 rotates with the horizontal cylinder 50, i.e., rotation of the cylinder 50 causes rotation of the hex key 38. In operation, due to the interconnection and engagement of the worm and worm wheel 46 and 54, when the external gear knob 34 of a tine body 26 is rotated, the hex key 38 of that tine body 26 rotates. The ends of the cylinder 50 and the shaft 42 may be retained in the tine body compartment 28 by bushings to reduce resistance against the compartment 28 walls when rotating. Alternatively or additionally, the compartment 28 may be made out of a polymer to reduce friction between the rotating shaft 42 and cylinder 50 and the compartment walls 28.

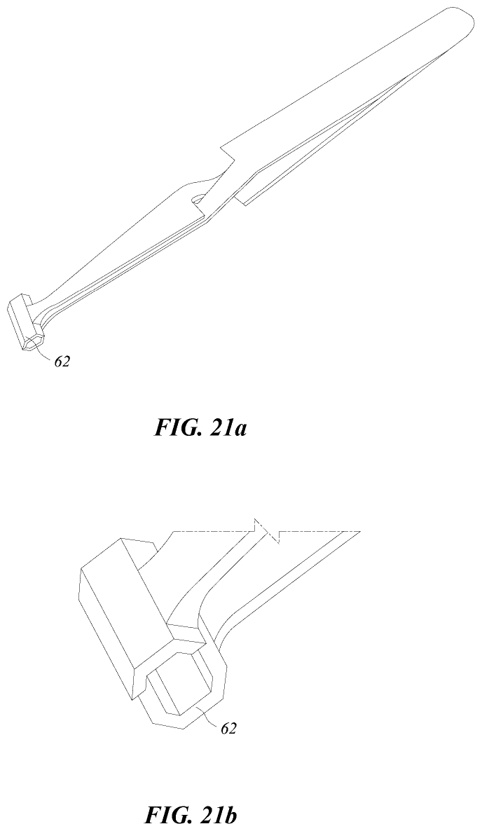

In some embodiments, the shaft 42, along with the worm 46 and the knob 34 can be slightly tilted. They can also be generally perpendicular to the worm wheel 54 attached to the cylinder 50. In some embodiments, only part of the worm wheel 54 contains teeth in order to save space inside the tine body compartment 28. The worm gear components 46 and 54, cylinder 50, hex key 38, shaft 42, and knob 34 may be made of a polymer, metal or an alloy thereof. The hex key 38 may be replaceable and may have the least yield strength out of all the tine body 26 components in order to reduce the risk of gear failure when excessive force is applied through the knob 34. The gear knob 34 may have different sizes and shapes depending on space availability but is large enough for a user to engage it to control rotation of the vertical shaft 42 and thus the hex key 38. In some embodiments, the user can rotate the gear knob(s) 34 with their fingers. In addition, or alternatively, and with respect to FIGS. 21a and 21b, a hex blade holder (or pliers) with a lug nut key 62 can be used to rotate the gear knob 34.

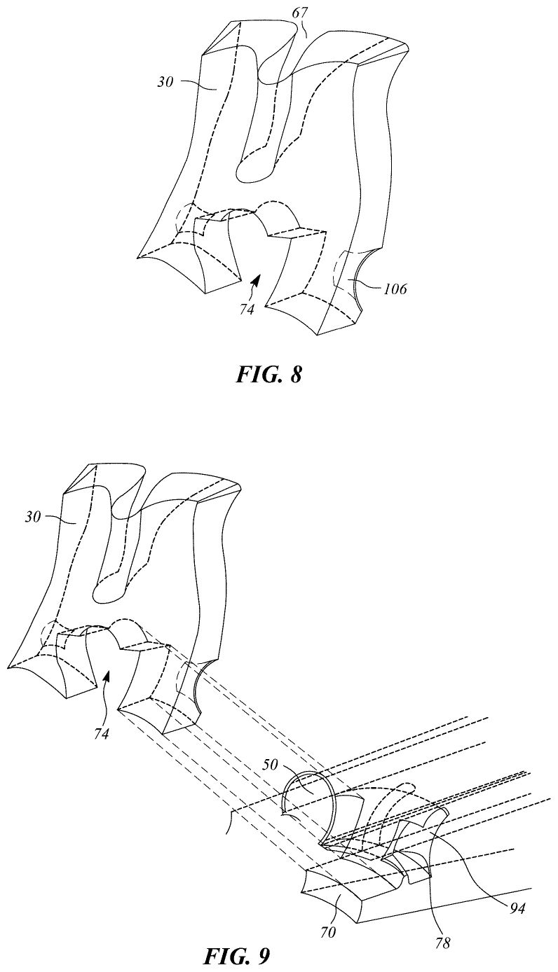

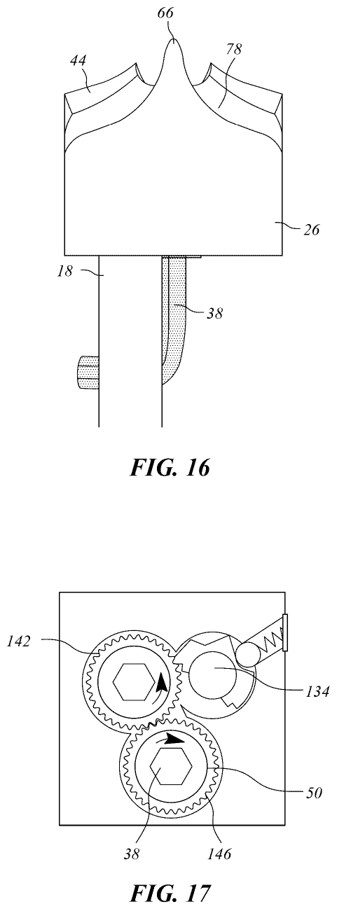

With respect to FIGS. 8, 9, 10j, and 16, the distal surface 44 of the tine body 26 is partially covered by the pad 30. A small extension 66 from the tine body 26 is received in a slot 67 in the pad 30 and provides extra support for, and maintains the integrity of, the pad 30 when the pad 30 is placed on the proximal surfaces of adjacent teeth. The tine body 26 includes a base with a bevelled extension 70 that follows the contour of the positive emergence profile of the gingival third of a tooth crown, preventing the matrix band (discussed below) and the sectional matrix ring from popping out of the intended site. As shown in FIG. 9, which shows a right side portion of the distal end 44 of the tine body 26 and how the pad 30 is positioned against the distal end 44 of the tine body 26, pad 30 sits on and above the bevelled extension 70, which may be made of a hard acrylic, is not covered by the pad, and is facing the positive emergence profile of the tooth surface so that the ring does not pop or slide out once inserted (as discussed in more detail below. Also, the center part of the gingival third of tine body 26 is not covered by the pad 30, i.e., the pad 30 includes a gap 74, which provides the hex key 38 and a blade (discussed below) access to the cylinder 50 in the compartment 28 and to a blade extension pathway 78 in the tine body 26.

With respect to FIGS. 1-2 and 11a-11b and 11h, the hex key 38 has a tapered end 80 that extends inward from the tine body 26 and is configured to fit into a loading edge 86 of a reusable blade 82. The hex key 38 can be secured to the blade 82 by a spring snap like a lock and key mechanism or other known ways to snapably engage two components. The blade 82 has a leading edge 87 and a trailing edge 89. The loading edge 86 of the blade 82 is preferably made of a polymer that provides a firm yet bendable movement. The tip 88 of the blade and the trailing edge 89 may be made of soft elastomeric material to prevent trauma to soft gingival tissue. Also, the trailing edge 89 of the blade 82 may be made of a softer elastomeric material for better adaption to follow the emergence profile of tooth surface. A tapered end 80 of the hex key 38 fits into the harder elastomeric core of the blade 82. The inner portion of loading edge 86 includes a tube 84 that receives the tapered end 80 of hex key 38. The tube 84 extends to become a spring snap lock that diverges into two parts that become extensions 90. As discussed below, one of the extensions 90 provides support to the one side of the sectional matrix 98, and one of the other extensions from the opposing tine supports the other side of the sectional matrix 98.

With respect to FIGS. 7, 9, 10h, and 11a, the blade 82 is connected to a tine body 26 by positioning the blade extensions 90 in the pathway 78 of the tine body 26 with the ends of the extensions 90 extending out of exits 94 on opposite sides of the tine body 26. The tapered and progressively flattened end 80 of the hex key 38 is inserted from the proximal side 40 of the tine body 26, passes through the cylinder 50, and extends to the distal side 44 of the tine body 26 and snap fits into the loading edge 86 of the blade 82. As seen in FIGS. 10h and 10i, the loading edge 86 of the blade 82 and tapered portion 80 of the hex key 38 are not positioned in the cylinder 50, but the hex key 38 can slide axially within the cylinder 50 and the blade 82 can move buccolingually. However, the L-shaped portion of the hex key 38 on the proximal end 40 and the blade extension 90 on the distal end 44 keep the body of the hex key 38 within the cylinder 50 after the snap locking of the blade 82 to the hex key 38.

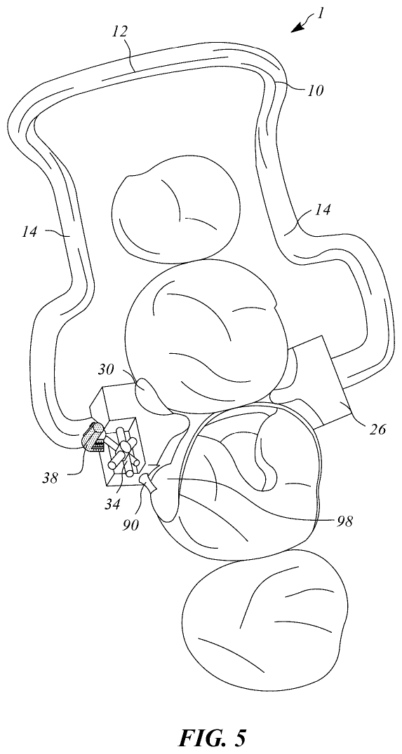

At this point, and with respect to FIGS. 4-6a, the sectional matrix band 98 can be connected to the blade extensions 90. The matrix band 98 is flexible yet firm enough to maintain its shape when placed interproximally between teeth. It may be made of stainless steel or clear polymer with a thin band 92 of colored area along the gingival margin of the matrix to easily visualize its edge when placing. Also, different colors, other than red (which is the color of blood and gum tissue), can be used to distinguish different size and shape of the matrix bands 98. The matrix band 98 includes two slit holes 102 proximate each corner thereof. The blade extensions 90 extending out of the exits 94 of the tine bodies 26 are inserted into the slits 102 to connect the matrix band 98 to the separator device 1 and keep the matrix band 98 in position against the pads 30 of the tine bodies 26 prior to the band 98 being positioned against a tooth that is to be restored. The gentle curve of the blade extension pathways 78 (FIG. 10h-10j) evens out the spring-back force exerted on the extensions 90 to prevent unwanted bending when the matrix band 98 (which may have a metal spring body) is spread out. The blade extension 90 may have a convex shape (like a tape measure) which helps keep it rigid when engaged with the matrix band 98. Further, with respect to FIG. 10h, the walls of the pathway 78 of the tine body 26 may define a convex shape to correspond to that of the blade extension 90 and provide guidance to the exit 94, where part of the tine body 26 wall facing the pad 30 is open to provide more room to accommodate flexing of the blade extension 90. With reference to FIG. 8, the pad 30 also contains a parabola-shaped concave section 106 to redistribute tension from the matrix band 98 when it causes the blade extensions 90 to flex.

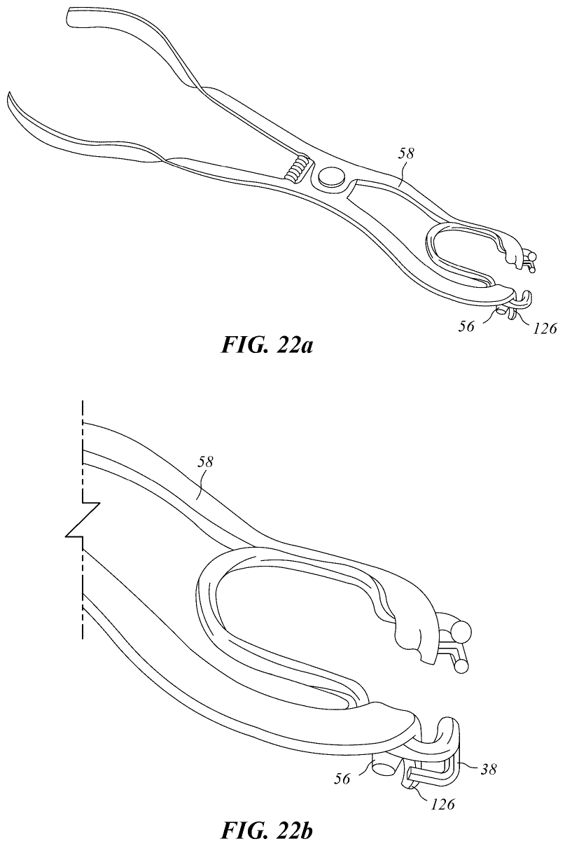

It should be noted that connection of the blades 82 to the device 1 and the connection of the matrix band 98 to the blades 82 can be done before inserting the device 1 in a patient's mouth. After the matrix band 98 is secured to the blade extensions 90, the device 1 can be used to position the matrix band 98 on the tooth needing restoration. With reference to FIGS. 22a and 22b, the user may use pliers 58 to insert the separator device 1 into the patient's mouth and position the matrix band 98. The pliers 58 include curved sections 56 that can be positioned in the notches 18 of the body 10 and, as shown in FIGS. 3 and 4, then the user can operate the pliers 58 to extend the legs 14, and thus the tine bodies 26, away from each other and expand the matrix band 98 for positioning between teeth and against the tooth needing restoration.

Once the matrix band 98 is positioned in place (as shown in FIGS. 5 and 7), the user can disengage the pliers 58 from the device 1, which allows restorative forces of the body 10 to spring the legs 14 back toward each other and to their original positions. As the legs 14 move back toward each other, each hex key 38 with the engaged blade 82 slides through the cylinder 50 buccolingually inside the tine body 26, causing the blade extensions 90 to be pulled away and withdrawn from the slits 102 of the matrix band 98. In addition, the restorative forces from the body 10 push the tine bodies 26 from proximal to distal, squashing the pads 30 on the tine bodies 26 against the tooth surfaces. As that happens, the parabolic shaped portion 106 of each pad 30 (FIGS. 8 and 9) is pushed into the exit 94 (FIGS. 9 and 10h) of the tine body 26, blocking the pathway 78 and thus preventing the portion of the blade extension 90 extending out of the exit 94 from moving into the pathway 78. This obstruction of the extension pathway 78 also restricts axial displacement of the hex key 38 in the distal-to-proximal direction. As shown in FIG. 7, when the device 1 is inserted, the lower portions of the legs 14 that are generally parallel to the center portion 12 lie below the occlusal plane at the gingival third.

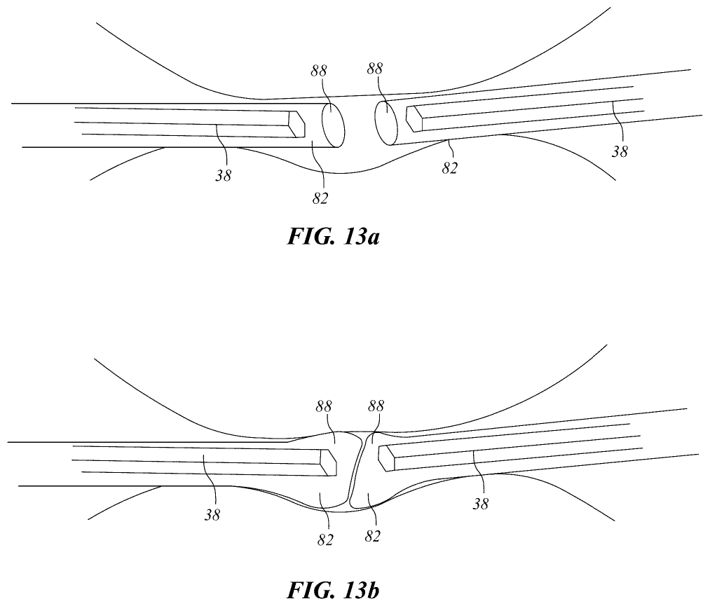

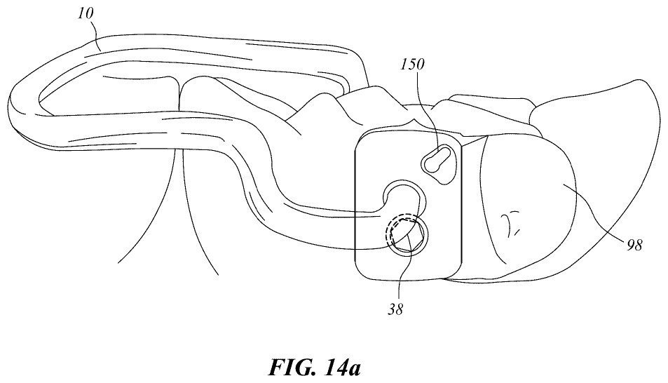

As shown in FIGS. 13a and 13b, after the matrix band 98 is placed between two teeth, the user pushes the hex keys 38 and blades 82 into the proximal space between the teeth, sliding along the gingival surface of the matrix band 98. With reference to FIG. 21, hex blade pliers 62 may be used to maneuver the L-shaped hex key 38 in and out of the tine bodies 26. The angled part of the hex key 38 resting on the proximal side 40 of the tine body 26 secures the blade 82 and prevents it from falling out of the cylinder 50. As discussed above, and with respect to FIGS. 13a and 13b, the tip 88 of the blade 82 is made of a softer elastic polymer, so when two opposing blades 82 are pushed inwardly from the tine bodies 26 toward and against each other, the elastic tips 88 of the blades 82 compress, filling up space between the teeth and pushing the matrix band 98 toward the concavity of the tooth surface, creating a tighter seal.

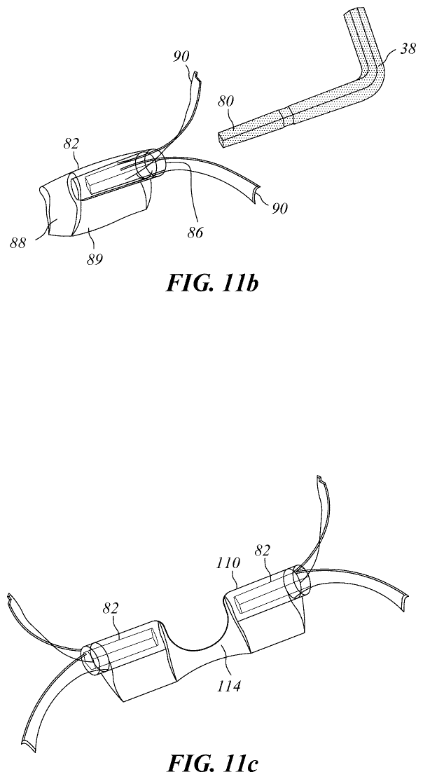

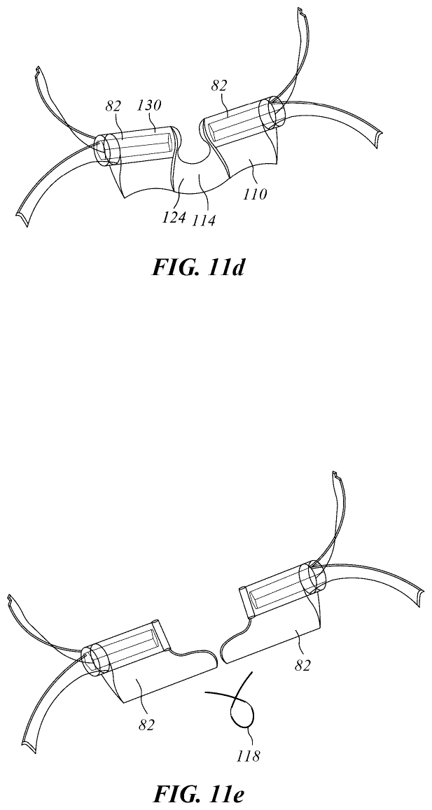

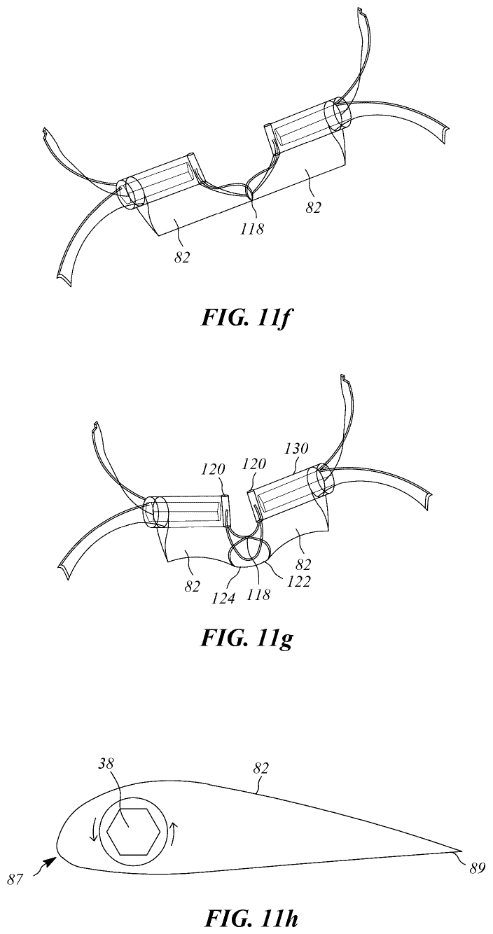

Alternatively, and with reference to FIGS. 11c and 11d, a double blade 110 can be used with the two tine bodies 26 instead of two single blades. The double blade 110 includes two blades 82 that are connected by a U-shaped arch 114. The arch 114 may be made of a medical-grade silicone rubber, polymer, or any other synthetic material that provides a sufficient tensile strength when it is stretched out and slide between two teeth. While the extended legs 14 of the body 10 spring back toward each other to securely position the matrix band 98 on the patient's teeth during insertion of the band 98, the arch 114 provides restorative forces that retract its two blades 82 together (as shown in FIG. 11d) under the contact area of two teeth. As another option for a double blade, and with reference to FIGS. 11e-11f, two blades 82 may be connected by a teardrop keyhole loop connector 118. Tubes 120 accommodate and retain ends of the connector 118. The connector 118 may be made of stainless steel, or an alloy thereof, in order to provide an elastic property that retracts two blades 82 together, as shown in FIG. 11g. Superimposed blade ends 122 define a convex blade edge 124 and provide additional mass to push the matrix band 98 even more toward the concavity of tooth surface below the gingival margin. The use of the pliers 58 to expand the legs 14 away from each other during the insertion process resists any relapsing force from the U-shaped arch connector 114 or teardrop keyhole loop connector 118 applied on the hex keys 38 until the device 1 is securely placed on the patient's dentition.

In operation, the blades 82 of the double blade 110 embodiments shown in FIGS. 11a-11g support the gingival third of the sectional matrix band 98, and the blade extensions 90 support the middle third of the matrix band 98 in relation to the separator device 1 when the pliers 58 are being used to expand the legs 14 away from each other as discussed above. At the same time, and with reference to FIGS. 22a and 22b, straight sections 126 of the pliers 58 can be used to engage the angled parts of the hex keys 38 (which are locked to the blades 82) to prevent recoiling of the arch 114 or connector 118 while the pliers 58 are being used to expand the body 10. In particular, the straight sections 126 of the pliers 58 holding the hex key 38 resist the recoil force from the u-shaped arch connector 114 or the teardrop keyhole loop connector 118, preventing the axial movement of the hex key 38 in the proximal-to-distal direction. With respect to the U-shaped arch connection 114, when it is stretched out (due to its elastic nature) during the insertion process, the arch 114 becomes sufficiently thin to navigate through interproximal contacts, both at the coronal and gingival levels.

After the matrix band 98 is positioned in the proximal space on a tooth, and the pliers 58 are removed and the legs 14 spring back toward each other, the U-shaped arch 114 and connector 118 of the double blade 110 embodiments recoil to form convex blade edges 124 as shown in FIGS. 11d and 11g, creating curvature that pushes the blades 110 more firmly into the gingiva.

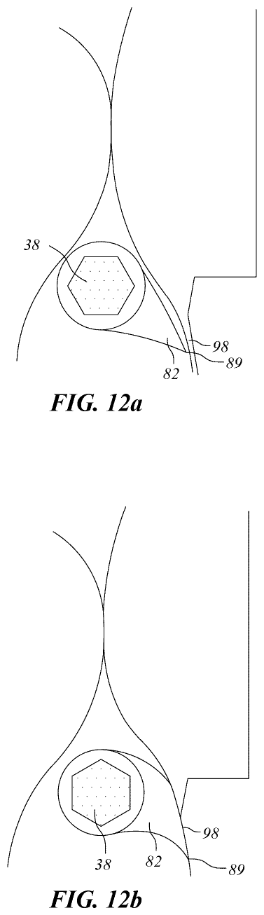

Once the matrix band 98 has been placed in position and the hex keys 38 and blades 82 have moved toward each other between the teeth to create space for the matrix band 98 and apply pressure against the matrix band 98 to seal it about the tooth needing restoration, the gear systems can be used to rotate the blades 82 to further seal the matrix band 98 along the gingival line of the tooth. In that regard, the user can rotate the gear knobs 34 (shown at FIGS. 1-3, 5, 7, and 10-1j), which, as discussed above, in turn, via the worm gear system, causes the hex keys 38 to rotate. With respect to FIGS. 12a and 12b, as a hex key 38 rotates, for example, in the counter clockwise direction, it causes the blade 82 (including the trailing edge 89) in which it is inserted, and locked to, to rotate up against the matrix band 98 along the gingival line and thus of create a tighter cervical seal of the band 98 against the tooth surface. When the double blade 110 is used, the arch 114 creates a spring back force to bring two blades together while rotating against the tooth surface.

The ability to rotate the blades 82 to form a cervical seal eliminates the need to select different sizes of wedges in the conventional wedge matrix system, which is done to account for the fact that most posterior teeth exhibit varying contour angles on the buccal and lingual aspects, respectively. Further, the use of the two gear systems in two tine bodies 26 that operate and move independently of each other provides better adaptability around the cervical margin of the matrix band 98 than conventional wedge systems, which only provide a seal on either buccal or lingual sides of the teeth. Indeed, some posterior teeth may have a deep liner concavity on the proximal surface, under the contact area of the two teeth, and a conventional wedge system often leaves the cervical seal open or loose with the matrix band 98. Further, unlike conventional wedge and sectional matrix systems, the amount of force exerted on the lingual and buccal aspects of the sectional matrix band 98 by the device 1 can be controlled by the rotation of the hex keys 38 (and thus the blades 82) from opposite tine bodies 26. In addition, by inserting hex keys 38 toward each other between adjacent teeth and rotating them (which creates the lever effects between these teeth), the device 1 allows a user to create additional space between the teeth to compensate the thickness of the matrix band 98. It should be noted that other mechanisms besides gear systems can be used to cause the blades to rotate such as lever mechanisms, alternative rotational systems, or even proximal blade configurations that do not rely on a rotating/gear feature. Further, a shaft having a shape other than a hex key can be used to extend through the tine bodies and/or engage and rotate blades.

FIG. 10k shows an alternative gear system that can be used in the tine bodies 26. It includes a ratchet wheel 130 mounted to the cylinder 50 and a spring-loaded pawl 134. The hex key 38 is received in the cylinder 50, and the ratchet wheel 130 engages the pawl 134. A hex blade holder 62 (as shown in FIG. 21) can be utilized on the proximal end of L-shaped hex key to rotate the hex key 38. The operating direction of the hex key 38 rotation is determined by the interaction between the ratchet wheel 130 and the pawl 134. In particular, a user can use the hex blade holder 62 to turn the hex key 38 (and thus rotate the blade 82 to engage the matrix band 98 to further seal the band 98 against the tooth as shown in FIGS. 12a and 12b). As the hex key 38 turns, the ratchet wheel 130 turns with it and against the pawl 134, and when the user stops rotating the hex key 38, the pawl 134 engages the ratchet wheel 130 to prevent it from rotating and thus locks the hex key 38 and blade 82 in place.

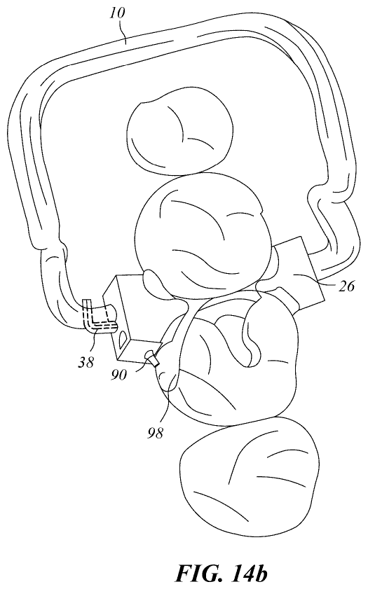

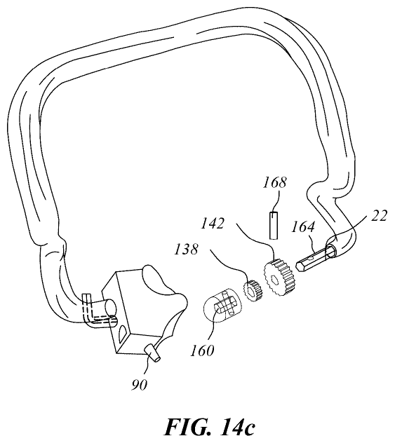

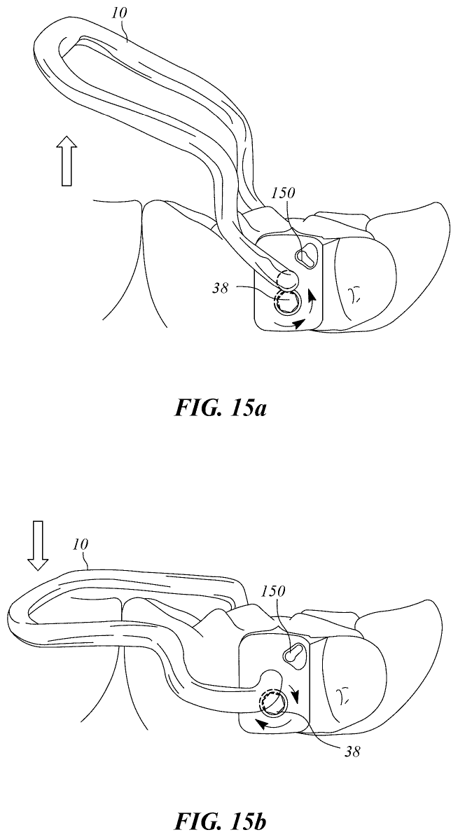

Another alternative gear system that uses a ratchet system is shown in FIG. 14-15 and 17. The system includes first and second spur gears 142 and 146, a ratchet wheel 138, and a pawl 134 to transfer a torque created by the vertical movement of the body 10 (as shown in FIGS. 15a and 15b) through the hex key 38 connected to the blade 82 in the proximal space. The spur gears 142 and 146, ratchet wheel 138, and pawl 134 may be made of stainless steel, titanium, or an alloy thereof. In this system, the distal end or tine 22 of each leg 14 that extends into the tine bodies 26 is connected to the first spur gear 142. The second spur gear 146 is mounted to the cylinder 50 that receives the hex key 38. The tines 22 are generally parallel to the central portion of the body 10 and may be received in bearings or bushings in the compartments 28 to reduce friction on the tines 22. Alternatively, the tine body compartments 28 can be made of a polymer like PTFE-filled PEEK or a glass fiber composite, which can also act as a dry bearing/bushing to reduce friction against the tines 22, cylinder 50, and/or the spur gears 142 and 146, and, thus, eliminate the needs of separate components like bearings or bushings. The direction of the hex key 38 rotation is dictated by a reversion (or torque wrench) lever 150 (as shown in FIG. 14a), which controls the pawl 134 (as shown FIG. 17).

In operation, the user can use the reversion lever 150 to set the pawl 134 such it allows the ratchet wheel 138 (and thus the first spur gear 142) to rotate in one direction, for example, counter clockwise. The user can then move the body 10 upward and downward (as shown in FIGS. 15a and 15b), which causes the tines 22, and thus the first spur gears 142 to rotate counter clockwise. The first spur gears 142 engage the second spur gears 146 and cause the second spur gears 146 and, thus the hex keys 38, to rotate clockwise. The rotation of the hex keys 38 causes the blades 82 to rotate toward the matrix band 98 and create a tighter cervical seal against the tooth surface (as shown in FIGS. 12a and 12b). Thus, the pawl 134 allows movement in one direction on the first spur gear 142 while preventing backlash, like a ratchet or torque wrench. Also, the force on the body 10 during the ratcheting operation generates a lever effect against the matrix band 98 on the cervical margin of the tooth, pushing two adjacent teeth apart, creating more proximal space. Any forces generated by either a gear system or a lever should not create tension or compression great enough to create permanent damage on the periodontal ligament or tooth structure, and yet it should be enough to increase the proximal space temporarily. To release the first spur gear 142, the user can move the reversion lever 150 to another position that causes the pawl 134 to disengage from the ratchet wheel 138 so that the first spur gear 142 can rotate in a direction opposite of the first direction.

With reference to FIG. 14c, the gear system may include a dome-shaped nut 160 at the distal end. The system further includes a hex extension 164 extending from the tine 22, which passes through bores of the first spur gear 142 and the ratchet wheel 138 and into the nut 160. A cross-pin 168 can be inserted through transverse holes in the nut 160 and the hex extension 164, which prevents the first spur gear 142, ratchet wheel 138 from sliding off the hex extension 164.

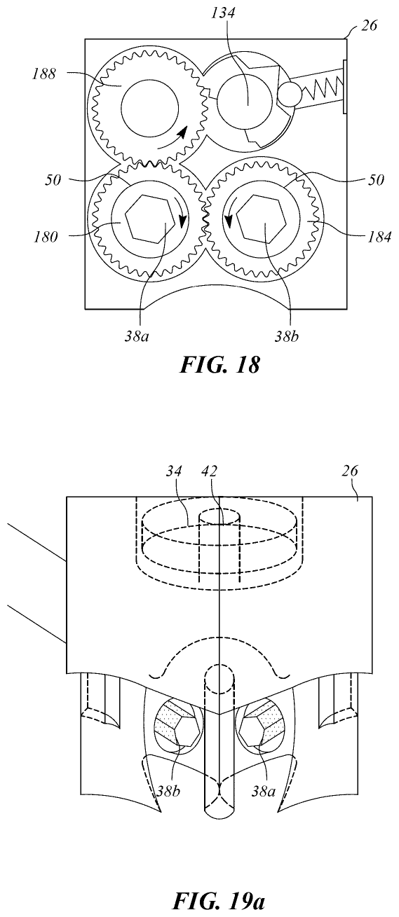

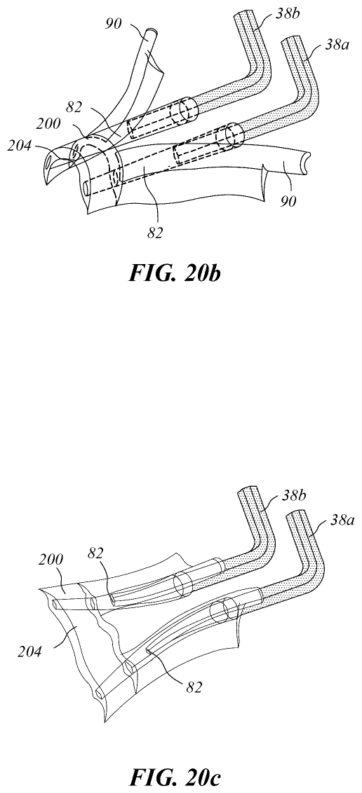

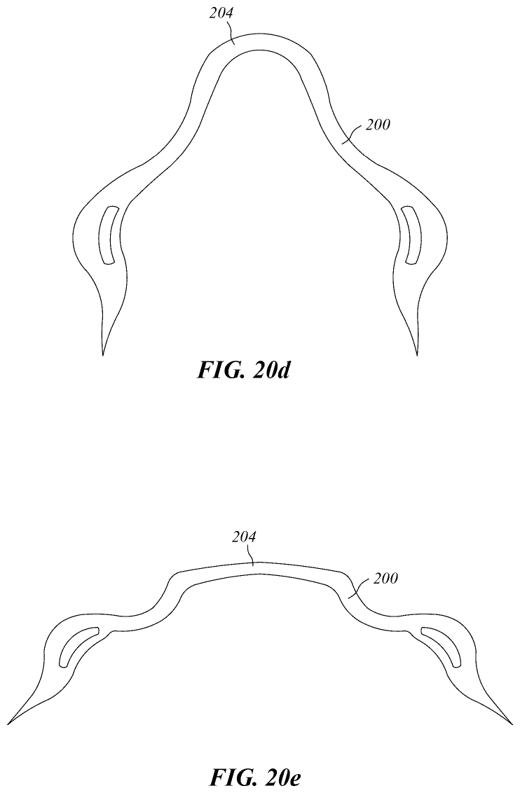

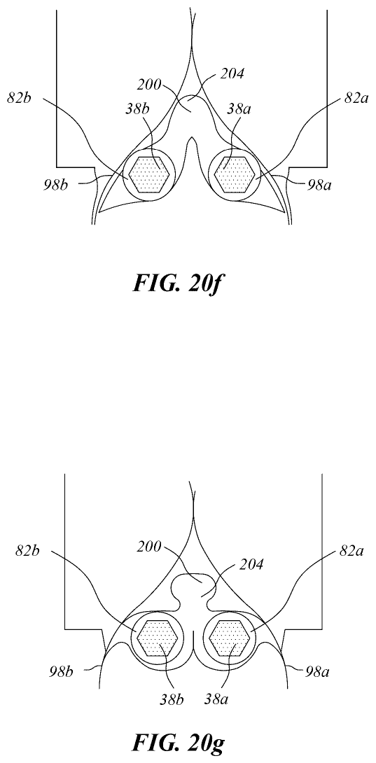

With reference to FIGS. 18 and 19a-19f, and 20a-20g, other tine body gear system embodiments are configured to work with a double blade system that can be used to engage two matrix bands on adjacent teeth to restore two adjacent proximal tooth surfaces simultaneously. With reference to FIGS. 20a-20c, the double blade system 200 includes two generally parallel blades 82 connected by a flexible arch 204. The arch 204 allows the two blades 82 to be stretched out away from each other (see FIG. 20e) for a tighter seal of matrix bands 98 on adjacent teeth. The blades 82 have extensions 90.

With reference to FIGS. 18 and 20a-20g, one embodiment of a gear system for the double blade system 200 is a ratchet system similar to that shown in FIG. 17 that includes spur gears 180, 184, and 188, where spur gears 180 and 184 are connected to parallel cylinders 50 that are configured to receive double hex keys 38a and 38b that are part of double blade system 200. Like the single blade system described above, the extensions 90 of the double blade system 200 are placed in pathways in the tine body 26 and the two loading edges of the system are positioned outside of two generally parallel cylinders 50 in the tine body 26. The two hex keys 38a and 38b are inserted into the cylinders 50 and into the loading of the double blade 200 and snapably connected to them. With respect to FIGS. 14a, 14b, 15a and 15b, after the device 1 is used to position the matrix band 98 in place, the user can move the center portion 12 up and down, which causes gear 188 to rotate in a counterclockwise direction, which in turn causes spur gear 180 (and thus hex key 38a) to rotate clockwise. As shown in FIG. 20f, this movement by hex key 38a causes the blade 82a to rotate up against a first matrix band 98a positioned on a first tooth. The clockwise rotation of spur gear 180 further causes spur gear 184 (and thus hex key 38b) to rotate in a counterclockwise direction. As shown in FIG. 20g, this movement by hex key 38b causes the blade 82b to rotate up against a second matrix band 98b positioned on a second tooth proximate the first tooth. A ratchet wheel can be mounted on the same shaft as the first spur gear 180 (as shown in FIG. 14c) and the ratchet wheel can engage the pawl 134 in a way similar to that described for the embodiment shown in FIG. 17.

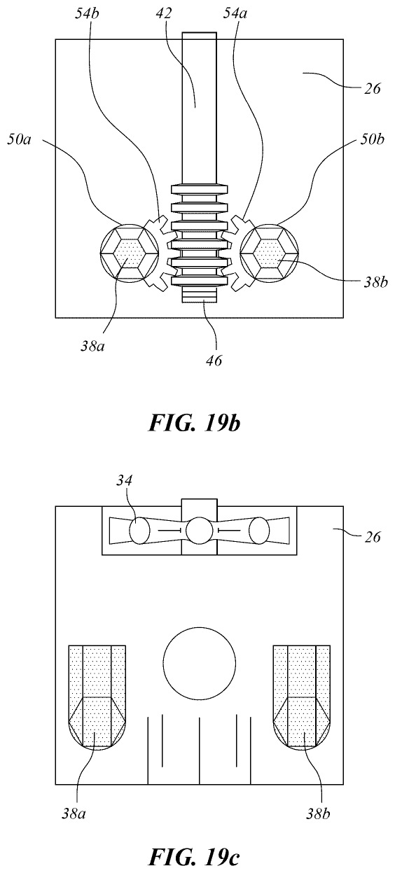

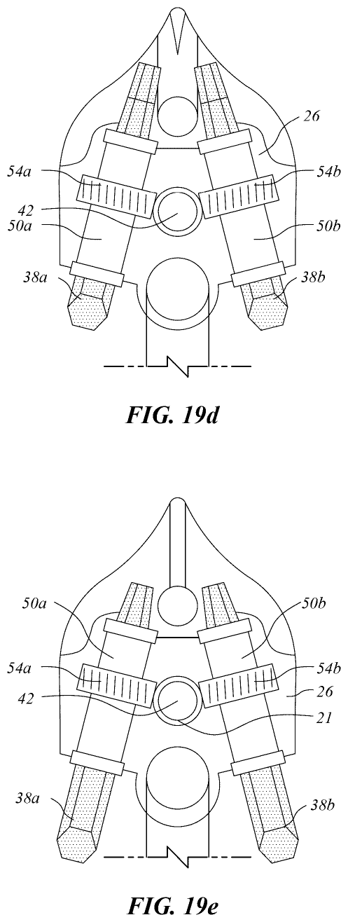

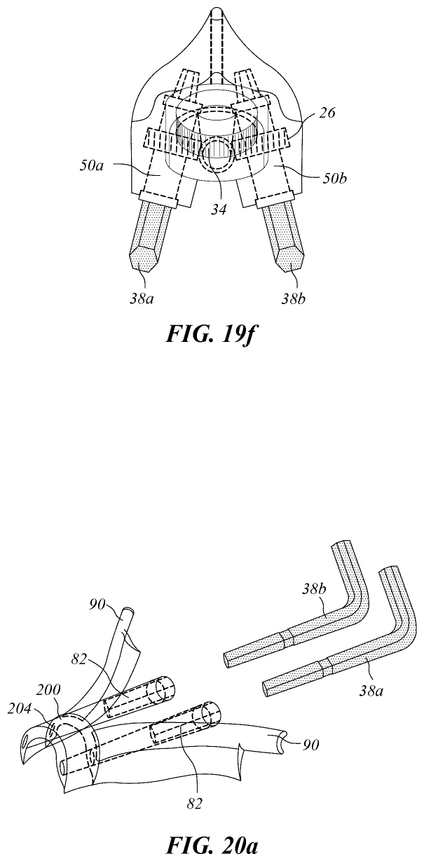

With reference to FIGS. 19a-f, another embodiment of a gear system for the double blade system 200 is a worm gear system similar to that shown in FIGS. 10a-10j. The tine body 26 includes two cylinders 50a and 50b that are at an angle to each other. They receive the hex keys 38a and 38b, respectively, such that tapered ends of the hex keys 38a and 38b extending out of the distal side of the tine body 26 are closer to each other than the angled ends of the hex keys 38a and 38b extending out of the proximal side of the tine body 26. In operation, the hex keys 38a and 38b are snapably connected to the loading edges of the double blade 200. Each cylinder 50a and 50b has a worm wheel 54a and 54b mounted to it. The shaft 42 has a worm 46 and is positioned between the cylinders 50a and 50b. When the gear knob 34 is rotated, the shaft 42 and worm 46 rotate, which causes the cylinders 50a and 50b (and thus the hex keys 38a and 38b) to rotate. As shown in FIGS. 20f and 20g, this rotation by the hex keys 38a and 38b causes the blades 82a and 82b to rotate up against the first and second matrix bands 98a and 98b, respectively, positioned on the adjacent first and second teeth.

Rotating two hex keys 38a and 38b inward in relation to each other as shown in FIGS. 20f and 20g generates a downward force on the arch 204 of the double blade 200, creating thrust in the arch 204 to diverge the blades 82 away from each other, like an arch bridge. This additional force created by the arch 204 can serve to increase proximal space to accommodate added thickness of two matrix bands 98a and 98b, especially with bands made of polymer, which are usually thicker than bands made of metal.

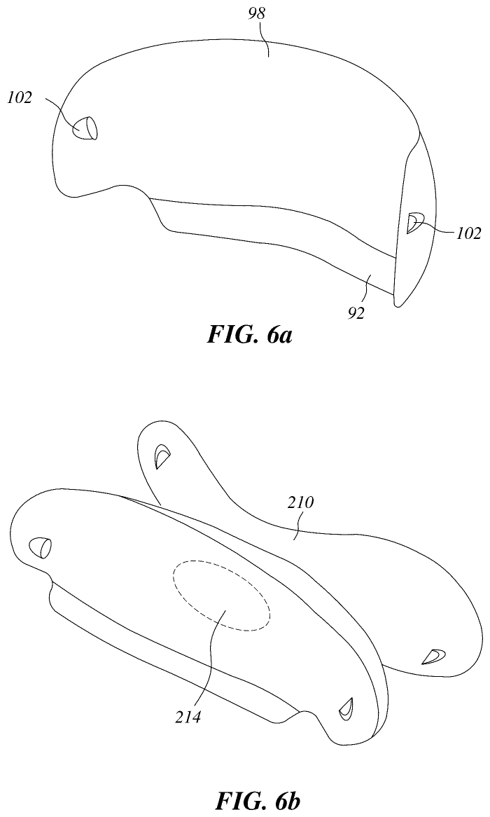

In another embodiment, a double matrix 210, as shown in FIG. 6b, can be used with the aforementioned double blade systems 200 to reduce the amount of space taken up by used two separate matrix bands 98. The double matrix 210 has a broad contact area of a bonded surface 214, which is thinner than having two separate matrices band 98 aligned next to and against each other.

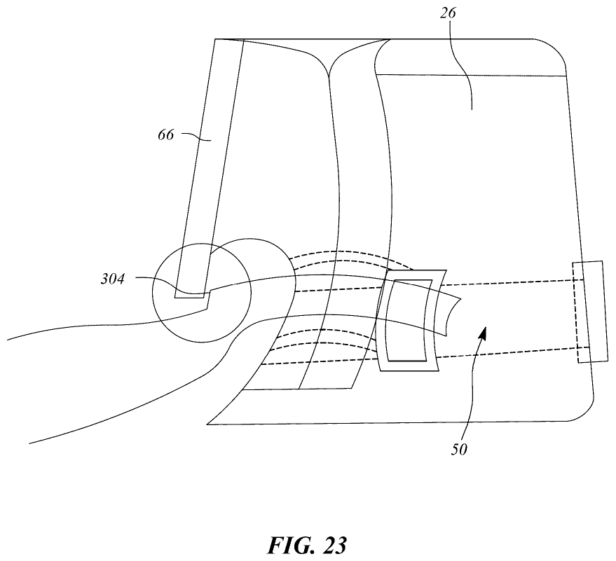

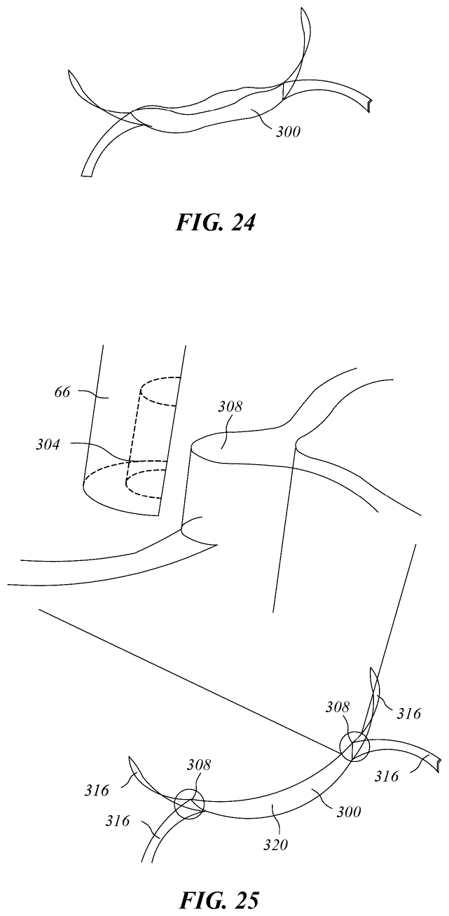

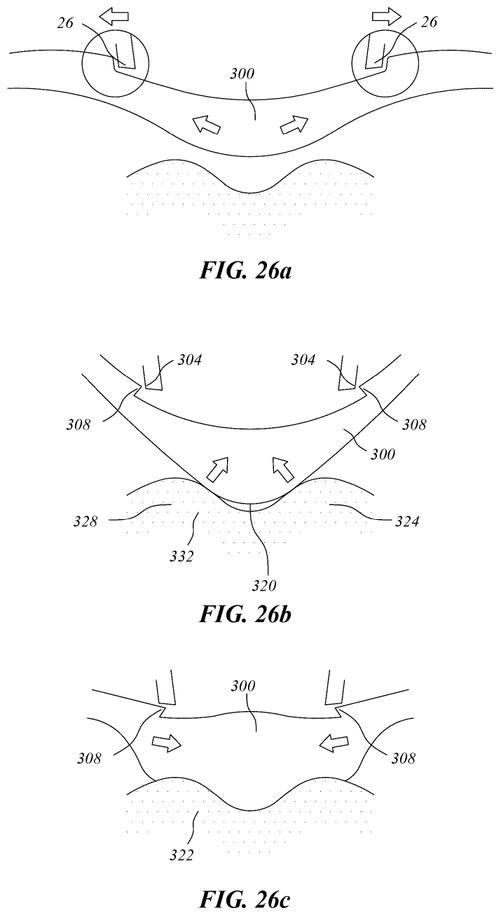

In another embodiment, and as shown in FIGS. 23-26, the tine bodies 26 do not include a gear system and operate with a flexible double blade system 300. The distal side extension 66 of the tine body 26 defines a notch 304. By way of example only, the notch 304 can be U-shaped but can also have other shapes. The blade system 300 includes a head 308 that can be retainably and releasably engaged by the notch 304. By way of example only, the head 308 can be U-shaped but can also have other shapes, including shapes that correspond to the shape of the notch 304. Each head 308 is at the point where the blade extensions 316 diverge from the body 320 of the blade 300. The heads 308 provide resistance to the recoil force generated by the U-shaped arch connector 114 or the tear drop key connector 118 (see FIGS. 11c-11g) of the blade 300. With reference to FIG. 26a, this arrangement holds the blade 300 securely in place between opposing tine bodies 26 while the separator 1 engages the matrix band 98 and stretches the blade 300 (as shown by the arrows) as discussed above. With reference to FIG. 26b, as the two tine bodies 26 approximate near the proximal surfaces of the teeth (not shown), the blade heads 308 on of the bodies 26 on each side gradually slide out of the notches 304. At the same time, the blade 300 recoils, bowing into a convex shape directed toward the concave space 320 defined by the buccal side 324 and lingual side 328 of the gingival tissue 332. A slight upward pressure from the gingival tissue 332 against the blade 300 (as shown by the arrows) causes the heads 308 to snap free from the notches 304. With reference to FIG. 26c, once the blade 300 is released from the tine body notches 304, the absence of resistance allows the recoil force (as shown by the arrows) to redistribute mass toward the center of the blade 300, thereby securing the matrix band (not shown) in position against the tooth.

In another embodiment, the body 26 may include a tube that is configured to allow for the blade 300 to be engaged such that the blade 300 pushes against the matrix band. This could be done in situations, for example, where the blade 300 does not recoil or is stuck or to further secure the blade 300 against the matrix band. For example, with respect to FIG. 23, the tube could be a cylinder 50 as discussed above, which receives and accommodates a hex key and can also provide a path for a rod or pin inserted axially to push the blade 300 distally if it becomes stuck.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A dental implement for inserting a matrix band, comprising:
an open ring with flexible legs;
a body positioned on one of the legs and that is configured to releasably engage the matrix band; and
a shaft that can move axially within the body, wherein the shaft is a hex key;
wherein, when the implement is inserted in a patient's mouth to position the matrix band along a first tooth, the shaft is configured to extend out of the body and between the first tooth and a second tooth adjacent the first tooth and move to apply pressure on the matrix band to press the matrix band against a portion of the first tooth.

2. The dental implement of claim 1, further comprising a flexible blade that is configured to receive the shaft, move with respect to the body, and extend between the first tooth and second tooth with the shaft.

3. (canceled)

4. The dental implement of claim 1, wherein the hex key is received in a cylinder in the body and the cylinder is shaped to correspond to the shape of the hex key such that rotation of the cylinder causes rotation of the hex key.

5. The dental implement of claim 4, wherein the body includes a gear system that includes (i) a gear knob external of the body and that is connected to a first gear in the body and (ii) a second gear connected to the cylinder and that engages the first gear, wherein rotation of the gear knob causes the cylinder and the hex key to rotate.

6. The dental implement of claim 5, wherein the gear system includes a ratchet wheel connected to an end of the leg and a gear connected to the cylinder that engages the ratchet wheel, wherein rotation of the open ring causes the ratchet wheel to rotate in a first direction, which causes the gear and cylinder to rotate in a second direction.

7. The dental implement of claim 6, wherein the gear system further includes a pawl that is configured to engage the ratchet wheel and a control lever, wherein the control lever can be moved to cause the pawl to engage and disengage the ratchet wheel.

8. The dental implant of claim 2, wherein the blade includes an extension that is configured to be positioned in a pathway in the body and extend from an exit in the body and releasably engage the matrix band.

9. The dental implement of claim 2, further including a second body that is positioned on another one of the legs and a second shaft that can move axially within the second body, wherein the blade includes first and second blade portions connected by a flexible arch and wherein the shaft of the body is connected to the first blade portion and the second shaft of the second body is connected to the second blade portion.

10. The dental implement of claim 2, wherein the blade includes first and second blade portions connected by a flexible arch, wherein the body is configured to receive a second shaft, the shaft being connected to the first blade portion and the second shaft being connected to the second blade portion.

11. The dental implement of claim 9, wherein the body includes a gear system that is configured to rotate the shaft a first direction and rotate the second shaft a second direction opposite the first direction.

12. A dental implement for inserting a matrix band, comprising:
an open ring with flexible legs that define a gap therebetween;
a body positioned on one of the legs;
a flexible blade configured to releasably connect to the body and to retain-a the matrix band;
a hex key that is received in a cylinder in the body and the cylinder is shaped to correspond to the shape of the hex key such that rotation of the cylinder causes rotation of the hex key;
wherein, when the implement is inserted in a patient's mouth to position the matrix band along a first tooth, the blade is configured to extend between the first tooth and a second tooth adjacent the first tooth and move to press a portion of the matrix band against a portion of the first tooth.

13. (canceled)

14. The dental implement of claim 12, further including a gear system including (i) a gear knob external of the body and that is connected to a first gear in the body and (ii) a second gear connected to the cylinder and that engages the first gear, wherein rotation of the gear knob causes the cylinder and the hex key to rotate.

15. The dental implement of claim 12, the blade includes an extension that is configured to bend to be positioned in a curved pathway in the body and extend from an exit in the body and releasably engage the matrix band.

16. The dental implement of claim 14, wherein the gear system includes a ratchet wheel connected to an end of the leg and a gear connected to the cylinder that engages the ratchet wheel, wherein rotation of the open ring causes the ratchet wheel to rotate in a first direction, which causes the gear and cylinder to rotate in a second direction.

17. The dental implement of claim 12, further including a second body that is positioned on another one of the legs, a first shaft that can move axially within the body, and a second shaft that can move axially within the second body, wherein the blade includes first and second blade portions connected by a flexible arch and wherein the first shaft of the body is connected to the first blade portion and the second shaft of the second body is connected to the second blade portion.

18. The dental implement of claim 12, wherein the blade includes a head configured to releasably engage a notch of the body, wherein when the ring is released from an expanded state to a contracted state, the head disengages from the notch of the body.

19. A dental implement comprising:
an open ring with flexible legs that define a gap there-between;
a body positioned on an end of each leg, wherein each body includes a gear system and a hex key that can move within the body;
a flexible blade mounted to each hex key that is configured to releasably engage a matrix band;
wherein, the legs are configured (i) to move away from each other in order to position the matrix band on a first tooth and (ii) to move toward each other such that each body is configured to engages the first tooth and a second tooth adjacent the first tooth and the blades disengage from the matrix band, and
wherein the hex keys are configured to (i) be moved axially toward each other between the first tooth and the second tooth such that the blades press against the matrix band, and (ii) be rotated via the gear system such that the blades rotate and press against the matrix band proximate the gingival margin.

20. A method for securing a matrix band to a tooth, comprising:
providing an open ring with flexible legs and a body positioned on at least one leg;
connecting a flexible blade to the body, the flexible blade having an extension extending therefrom;
releasably connecting a matrix band to the extension of the flexible blade;
positioning the matrix band along a first tooth,
flexing the legs to cause the extension of the flexible blade to be released from the matrix band and to drive the blade between the first tooth and an adjacent tooth to cause the blade to secure the matrix band in place against a prepared surface of the first tooth.

21. The dental implement of claim 2, wherein the blade is axially moved by axial movement of the shaft.

22. The dental implement of claim 1, wherein the shaft is non-circular.
